(19) United States
(12) Patent Application Publication
(10) Pub. No.: US 2011/0147094 A1
(43) Pub. Date: Jun. 23, 2011

(54) WEIGHING SCALES

(76) Inventor: Stephan Gerster, Wachtberg-Pech (DE)

(21) Appl. No.: 12/377,729

(22) PCT Filed: Jan. 12, 2007
(86) PCT No.: PCT/DE07/00065

§ 371 Date: Jun. 4, 2010

(30) Foreign Application Priority Data
Aug. 15, 2006 (DE) 10-2006-038-399.0

(51) Int. Cl. G01G 19/50; G01G 23/38

(52) U.S. Cl. 177/4; 177/50

(57) ABSTRACT

Weighing scales include at least one load cell, a weighing base configured to act on the at least one load cell and having a platform for a person, and a pillar having a pillar head disposed on the pillar, wherein a display device including an operating unit and a power source is disposed in the pillar head. The scales also have a measuring device for body-specific information and having at least one electrode, wherein the at least one electrode is disposed in at least one of the pillar head and a connecting piece between the pillar head and at least one of the weighing base, an associated frame and an associated base plate. A processor is included that is configured to process at least one signal measured from the at least one electrode.

### CROSS REFERENCE TO PRIOR APPLICATIONS

This is a U.S. National Phase Application under 35 U.S.C.§371 of International Application No. PCT/DE2007/000065, filed on Jan. 12, 2007, which claims priority to DE 10 2006 038 399.0, filed on Aug. 15, 2006. The International Application was published in German on Feb. 21, 2008 as WO 2008/019637 A1 under PCT 21 (2).

### FIELD

The present invention relates to scales with at least one load cell, with a weighing base that acts upon the load cell and that has a platform for the person, with a pillar having a head, with a display device that is installed in the pillar head and that has an operating unit and a source of power, whereby, in order to ascertain other body-specific information, especially the body fat (optionally the percentage of fat, water and muscle in the body), an additional measuring device with electrodes is provided, and whereby a processor serves to evaluate or process measured signals.

### BACKGROUND

Scales with an integrated body fat measuring device have been known in actual practice for quite some time. In this context, reference is hereby made to German patent application DE 199 43 651 A1, this publication referring specifically to a set of scales in which a flat electrode is provided for each foot on the weighing base.

Scales having an integrated fat-measuring function regularly operate according to the so-called bioimpedance method. The weighing base or platform for the person to be weighed is equipped with electrically conductive electrodes which, in turn, are fed with a low current. This current is passed through the body of the user, as a result of which the body-specific electric resistance can be determined. This body resistance and the weight ascertained by means of the load cell as well as, optionally, other body-specific data—if applicable, gender, age, etc.—then make it possible to determine the fat content. The scales known from actual practice that have an integrated fat-measuring function are scales in which the electrodes are glued onto the platform. The electrodes are electrically connected by means of direct contacts.

It should also be pointed out that scales with a display pillar already exist, namely, scales in which the display device along with the operating part is installed in a pillar head so that the scales are easier to read and operate. Here, the pillar is normally installed in a frame or in a base plate, whereby the load cell or load cells operate(s) between the frame or the base plate and the weighing base. This means that reproducible weighing is only possible if the person to be weighed does not come into contact with the pillar or with the pillar head that encompasses the operating unit.

The scales known from actual practice are problematic in a number of ways. Arranging the electrode in or on the weighing base entails the disadvantage that the electrodes easily become dirty. Moreover, the arrangement there makes it necessary for the person to stand barefoot on the weighing base in order to be weighed. This is particularly problematic when the scales are placed in pharmacies, but also in fitness centers, at doctors' offices, etc., in view of hygiene-related considerations. Moreover, placing electrodes onto the weighing base has the additional drawback that the electrodes wear out quickly there, not least due to the fact that they constantly have to be cleaned. And finally, a considerable amount of installation work is required within the scope of such an arrangement of the electrodes.

### SUMMARY

An aspect of the present invention is to provide scales having an integrated measuring device for additional body-specific information so that the scales lend themselves for convenient use in public areas.

In an embodiment, the present invention provides weighing scales including at least one load cell, a weighing base configured to act on the at least one load cell and having a platform for a person, and a pillar having a pillar head disposed on the pillar, wherein a display device including an operating unit and a power source is disposed in the pillar head. The scales also have a measuring device for body-specific information and having at least one electrode, wherein the at least one electrode is disposed in at least one of the pillar head and a connecting piece. The connecting piece is disposed between the pillar head and at least one of the weighing base, an associated frame and an associated base plate. A processor is configured to process at least one signal measured from the at least one electrode.

### BRIEF DESCRIPTION OF THE DRAWINGS

There are various possibilities to configure and refine the teaching according to the invention in an advantageous manner. In this context, reference is hereby made, on the one hand, to the claims below and, on the other hand, to the following explanation of two preferred embodiments of the invention making reference to the drawings. Preferred versions and refinements of the teaching are also elaborated upon in general in conjunction with the explanation of the preferred embodiments of the invention making reference to the drawings. In the drawings,

FIG. 1 shows a schematic view of a first embodiment of a set of scales according to the invention, in which the electrodes for the bioimpedance measurement are installed in the pillar head;

FIG. 2 shows a schematic view of the object from FIG. 1 as seen from the rear;

FIG. 3 shows a schematic view of the object from FIGS. 1 and 2 as seen from above;

FIG. 4 shows a schematic and enlarged view of the pillar head of the object from FIGS. 1 to 3;

FIG. 5 shows a schematic view of the object from FIG. 4 as seen from below;

FIG. 6 shows a schematic view of a second embodiment of a set of scales according to the invention;

FIG. 7 shows a schematic view of the object from FIG. 6 at a slant as seen from above;

FIG. 8 shows a schematic view of the object from FIGS. 6 and 7 as seen from the side; and

FIG. 9 shows a schematic view of the object from FIGS. 6, 7 and 8 as seen from the front.

### DETAILED DESCRIPTION

In an embodiment, the scales are characterized in that the electrodes are installed in the pillar head and/or in a connecting piece between the pillar head and the weighing base or a frame or a base plate, and in that the display device along with the operating unit is installed in the pillar head.

It has been recognized according to the invention that the construction and production of the scales according to the invention can be considerably simplified if the functional units—all of them—are installed in the pillar head. It is especially important, for instance, when the body fat is being determined, for electrodes that serve to feed a low current to be installed in the pillar head, so that the low current is fed into the body through the hands and arms. Thus, with the scales according to the invention, it is not necessary to step onto the scales or weighing base barefoot. Consequently, this makes a major contribution towards the hygienic utilization of such a set of scales.

Furthermore, it can be assumed that all of the electronic components, except for the load cells, are installed in the pillar head. This substantially simplifies the construction of the scales according to the invention, especially since only the signals of the load cell have to be supplied to the processor.

It is fundamentally conceivable for electrodes to also be installed in the weighing base, namely, in addition to the electrodes of the pillar head. In this context, it can even be provided that that the user selects the mode of operation. Both pairs of electrodes can likewise augment each other.

In concrete terms, it is conceivable for two handles comprising the electrodes to be installed in the pillar head so that the person then holds or grips these handles. Instead of providing handles, a ring that encompasses the electrodes can also be installed in the pillar head. Ring segments or the like that each encompass one electrode can also be employed.

In a particularly advantageous manner, a panel that encompasses the electrodes is installed in the pillar head, whereby, in an additionally advantageous manner, the panel is made of glass. The panel can be configured to be approximately square, optionally with curved or arced edges, or else round, preferably circular. On both sides, the panel is configured with gripping areas that encompass the electrodes. In a particularly advantageous way, the gripping areas are configured as wavy or profiled edges of the panel, which allow a precise positioning of four fingers when the hand is placed around or behind the gripping areas.

Mention was made above of a panel with integrated electrodes. In this context, it should be pointed out that the panel can have any desired shape. It is likewise conceivable for the panel to consist of several individual elements that form a whole panel. Especially with an eye towards a symmetrical configuration, it is advantageous if the panel consists essentially of three partial panels. Within the scope of the configuration of the panel made up of three partial panels, it is also advantageous if the display device is installed in the center panel segment. The operating unit or an operating element belonging to the operating unit can also be installed in the center panel segment.

In an advantageous manner, the above-mentioned gripping area with at least one electrode is installed in the side panel segments, so that a measurement is possible when the sides of both panel segments are gripped. In this context, it is also advantageous if the operating unit or the operating elements of the operating unit is/are installed in the side panel segments, especially since, if the operating elements are properly arranged, they can then be operated with the thumb in order to, for example, trigger functions by touching or by pressing said element with the thumb while the other four fingers are on the electrodes so that a measurement can be made.

Both from the standpoint of design and esthetics, it is advantageous if the operating elements extend through the panel segments and connect them to each other and to the pillar or pillar head. No additional assembly elements are needed within the scope of such an embodiment, but rather, the panel segments can be connected to the pillar or pillar head by means of operating elements that extend all the way through.

If the panel is made up of three individual panel segments, it is possible for two of the panel segments to be arranged in a plane at a distance from the center panel segment, preferably above it and at least slightly overlapping the center panel segment. Here, the panel segments can complement each other to form a projecting surface, whereby the panel segments preferably form a projected circular area. In this context, it is conceivable for the center panel segment to extend at least slightly beyond the edges of the two outer panel segments, whereby such an extension is possible in the longitudinal direction at both ends of the center panel segment. At this juncture, it should be mentioned that the panel segments can have a background of any color, whereby it is also conceivable for the glass to be completely or partially etched or else roughened in some other way.

The electrodes are preferably in the form of vapor-deposited surfaces made of an electrically conductive material, whereby these are especially metal surfaces. Particularly in case of a circular panel and of an arrangement of the electrodes on the edge of the panel or of the outer panel segments, it is advantageous for the electrodes to be configured as curved strips.

Regarding the function of the scales, it is particularly advantageous for the pillar—unlike in the state of the art, where it is installed in a special frame or in a base plate—to be installed or fastened directly on the weighing base. This entails the great advantage that the weight measurement via the load cells is not falsified when the person holds onto the panel or panel segments and the electrodes formed there. Thus, the user stands on the weighing base and touches the pillar—either for a body-fat measurement or for operating the scales—without this causing any change in the weight being exerted on the weighing base that would occur if the person were to lean on something on the outside. On the contrary, the pillar, along with the weighing base and the person who is standing on it and possibly touching the panel, forms a closed system that is supported via the load cells on a substrate. This largely prevents erroneous measurements of the body weight.

The pillar is advantageously made of an aluminum section although other materials can also be employed. For instance, the pillar can be a column having a round or rectangular, preferably square, cross section.

In an advantageous manner, the pillar is shaped in the form of a flat column, preferably having an oval or lenticular cross section, which gives it a very special look. Moreover, as seen from the front, the column appears broad and sturdy whereas it conveys a slender impression from the side.

With an eye towards making it convenient to operate and to read the display, the pillar is angled just below the pillar head. This angle is within the range from 45° to 90°, whereby, in an advantageous manner, the angle selected is such that the pillar head extends towards the user like a lectern.

In this vein, it is particularly advantageous if the angled part of the pillar, that is to say, the part that forms the actual pillar head, serves as the housing for the display device and optionally for the operating unit. It is likewise advantageous for the processor and the source of power, preferably in the form of a battery or an accumulator, to be arranged in the pillar or in the pillar head. As far as the source of power is concerned, it is also conceivable to arrange a power pack inside the pillar or pillar head, so that the scales can be plugged directly into a wall outlet.

The angled part of the pillar serves for fastening the panel, especially the center panel segment when the panel is made up of multiple parts. Consequently, it is also advantageous if the angled part of the pillar is covered by the panel, preferably by the center panel segment. This ensures protection of the display or other functional elements provided in the angled part of the pillar.

The weighing base that encompasses the platform has already been mentioned above. It can be made of a wide array of materials and advantageously consists of unbreakable glass.

The scales according to the invention can advantageously also be utilized by wheelchair users. For this purpose, the weighing base is configured as a ramp for a wheelchair. It is likewise conceivable for the weighing base to comprise a ramp that allows a wheelchair to roll onto the weighing base. In order to create the ramp, an integral part of the weighing base can be configured so that it can be folded open. As an alternative, an additional ramp-like piece could be mounted on the weighing base and fastened there.

With an eye towards achieving further safety for wheelchair users, the weighing base can have support bars, preferably in the form of a railing, whereby the weighing base should be surrounded at least partially by the support bars or railing. Within the scope of such an embodiment, wheelchair users can pull themselves and their wheelchairs onto the weighing base by holding on to the support bars or the railing. The support bars or railing could comprise the electrodes, so that the other body-specific data can be measured when the person holds on to the support bars or railing.

Moreover, it is advantageous if a printer for printing out the measured results is installed in the pillar or in the pillar head. In this context, the printer can be configured as an extremely compact tape printer. It is likewise conceivable that the acquired or processed measured data can be saved for each individual user by means of other media such as, for instance, memory cards or USB chips.

Another advantage results from the provision of an interface for data transmission, whereby this, too, can be installed in the pillar or in the pillar head. This device can be, for example, an infrared interface or a Bluetooth interface. In such a case, the user can store and thus record his/her body-specific measured values on a cell phone, organizer or other mobile data media, whereby more complex data-processing, ranging all the way to a graphic display of the measured values, is possible.

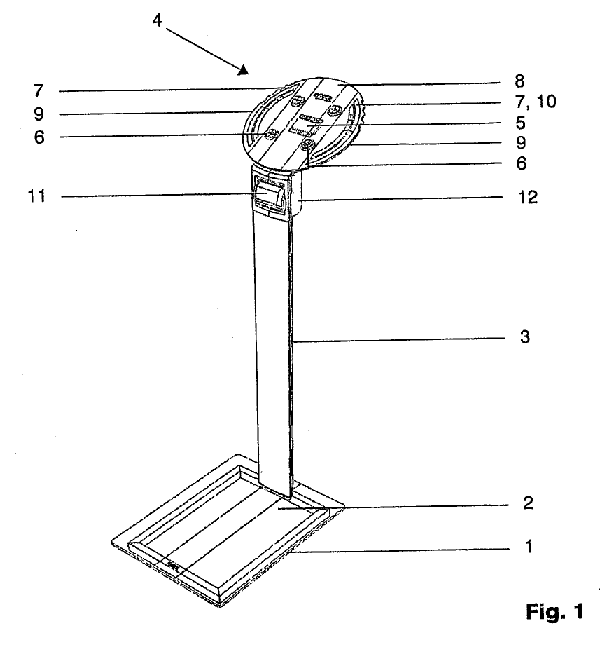

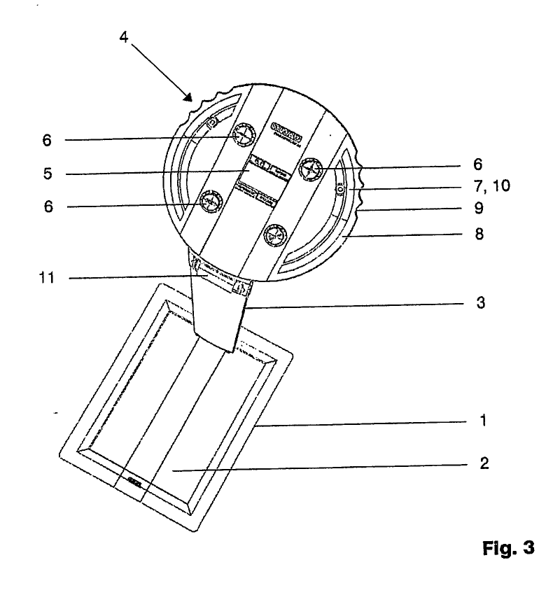

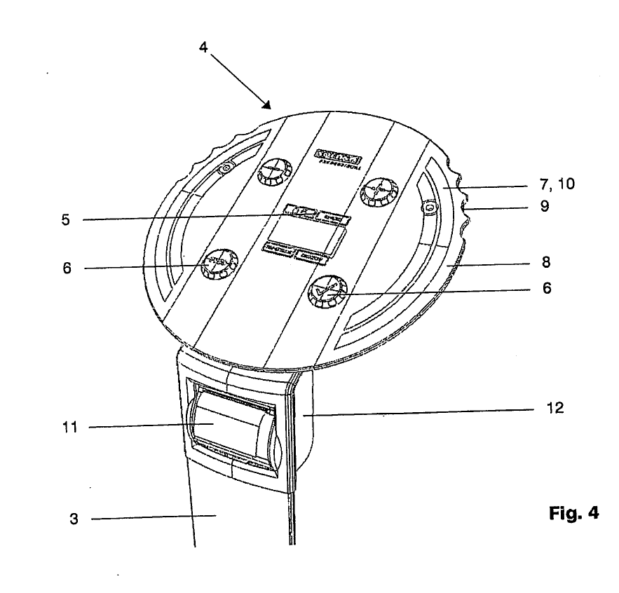

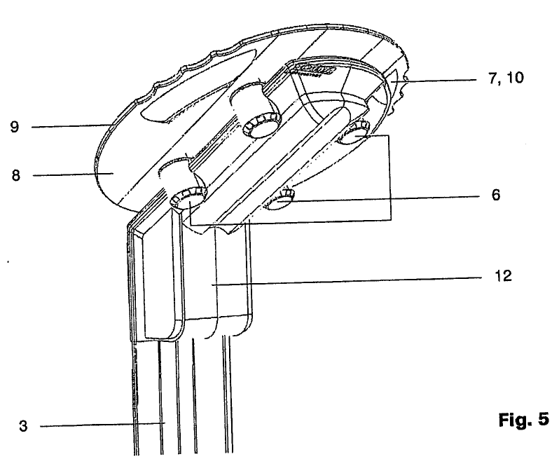

FIGS. 1 to 5 shown a first embodiment of a set of scales according to the invention, whereby the weighing base 1 shown there acts upon load cells (not shown) towards the substrate or floor. The weighing base 1 comprises a platform 2 on which the person can stand. A pillar 3 with a head 4 extends from the platform 2. A display device 5, which is normally simply referred to as the display, is installed in the pillar head 4. Operating elements 6 of an operating unit are likewise provided. A source of power in the form of a battery (not shown) is installed in the pillar 3 or in the pillar head 4. Another measuring device encompassing the electrodes 7 is provided for purposes of ascertaining the body fat or else the percentage of fat, water and muscle in the body. A processor serves to evaluate or process the measured signals stemming from the load cells as well as from the electrodes 7.

In the manner according to the invention, the electrodes 7, corresponding to the depictions in FIGS. 1 to 5, are installed in the pillar head 4 and/or in a connection between the pillar head 4 and the weighing base 1 or in a frame or in a base plate. The same applies to the display device 5 and to the operating elements 6, which are likewise installed in the pillar head 4.

FIGS. 1 to 5 clearly show that a glass panel 8 having a circular shape is installed in the pillar head 4. Gripping areas 9 configured in the form of wavy or profiled edges are provided on both sides of the edge of the glass panel 8 and they allow a precise positioning of four fingers of the hand around or behind the gripping areas. The electrodes 7 provided under the glass panel 8 are in the form of curved metal strips 10, the latter being vapor-deposited on the bottom surface of the glass.

FIGS. 1 to 5 clearly show that an angled area of the pillar 3, together with the glass panel 8, forms the pillar head 4, whereby the glass panel 8 covers the entire angled area of the pillar 3, thus especially also the display device 5 and the operating elements 6.

As far as the pillar 3 is concerned, it should be pointed out that it can be connected directly to the weighing base 1, so that it is possible for users to support themselves on the pillar head 4 or on the glass panel 8 during the measuring operation without this falsifying the results of the weight measurement. By the same token, it is also conceivable for the pillar 3 to be fastened to a frame or to a base plate independent of the weighing base 1. In such a case, the pillar must not be touched when the weight is being measured and it is necessary to ensure that the person stands on the weighing base 1 without moving during the weighing procedure.

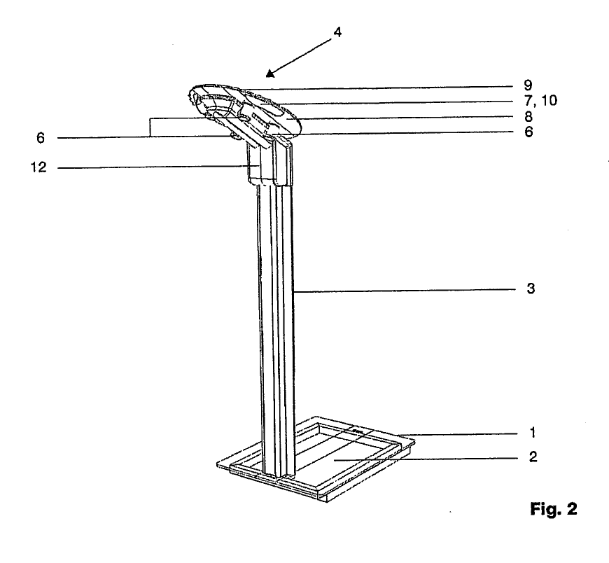

In FIGS. 1 and 2, it is indicated that a tape printer 11 is installed in the pillar 3 in the area of the pillar head. The other functional units, especially also the source of power in the form of a battery, can be accommodated in the housing 12, mounted at the rear as a component of the pillar 3 and of the pillar head 4.

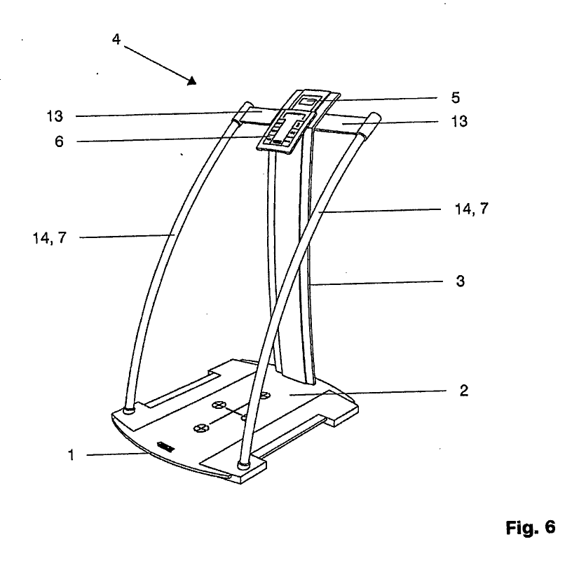

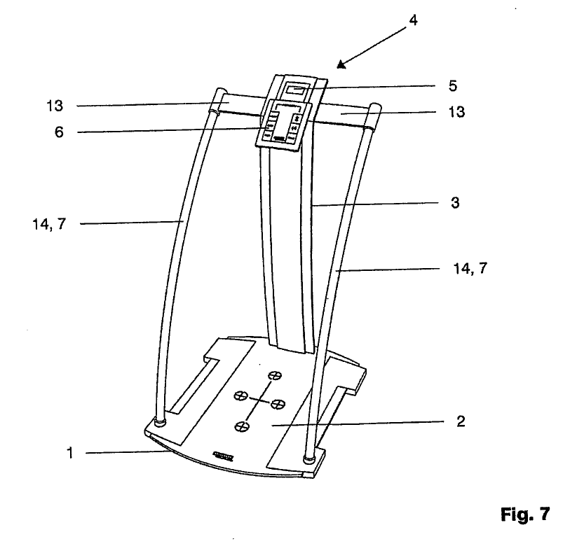

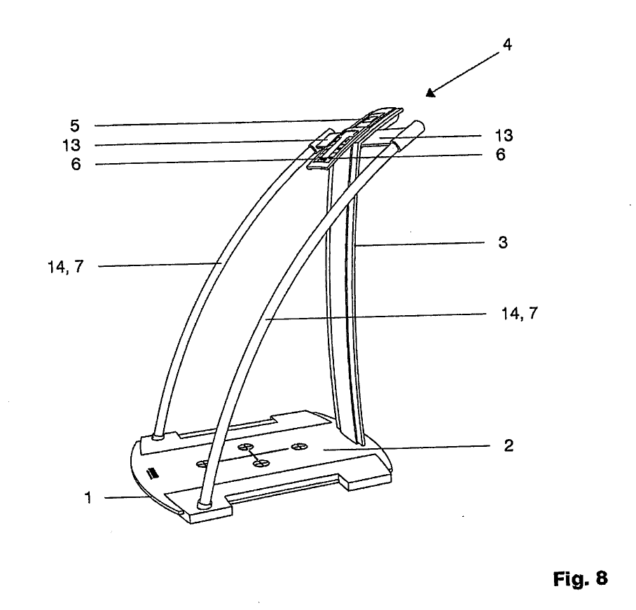

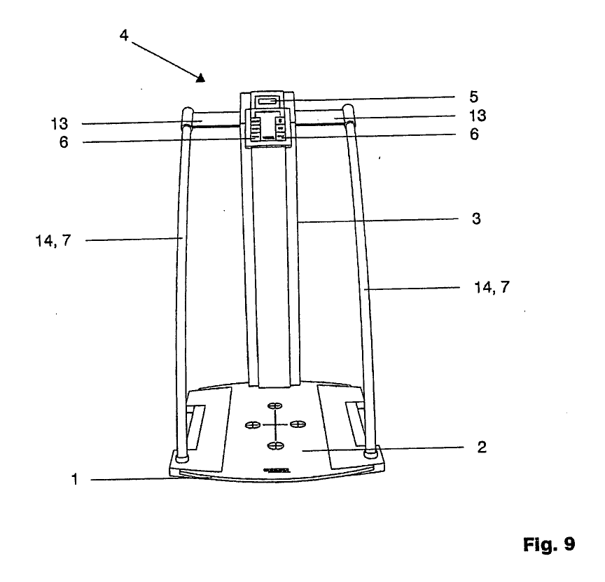

FIGS. 6 to 9 show a second embodiment of a set of scales according to the invention, in which the electrodes are configured in a connection area between the pillar head 4 and the weighing base 1 or a frame or a base plate.

Concretely speaking, holding arms 13 extend sideways from the pillar head 4 and they serve to receive metal rods 14 that extend correspondingly from the lateral holding arms 13 towards the weighing base 1 or to the ground.

The metal rods 14 serve, on the one hand, as electrodes 7 and, on the other hand, as a support for users to hold on to in order to ensure they can stand securely.

Concerning additional details that have already been elaborated upon above or that cannot be gleaned from the figures, for the sake of avoiding repetitions, reference is hereby made to the general part of the description.

In conclusion, it should be pointed out that the embodiments explained above serve merely as an example of the claimed teaching but that the latter is not restricted to these embodiments.

1-38. (canceled)

39. Weighing scales comprising:
at least one load cell;
a weighing base configured to act on the at least one load cell and having a platform for a person;
a pillar having a pillar head disposed on the pillar, wherein a display device including an operating unit and a power source is disposed in the pillar head;
a measuring device for body-specific information and having at least one electrode, wherein the at least one electrode is disposed in at least one of the pillar head and a connecting piece, the connecting piece being disposed between the pillar head and at least one of the weighing base, an associated frame and an associated base plate; and
a processor configured to process at least one signal measured from the at least one electrode.

40. The weighing scales as recited in claim 39, wherein the body-specific information includes body fat information.

41. The weighing scales as recited in claim 39, wherein the at least one electrode is disposed in the weighing base.

42. The weighing scales as recited in claim 39, wherein the at least one electrode includes at least two electrodes, and wherein the pillar head includes two handles each including at least one of the at least two electrodes.

43. The weighing scales as recited in claim 39, wherein the pillar head includes a ring encompassing the at least one electrode.

44. The weighing scales as recited in claim 39, wherein the pillar head includes a panel including the at least one electrode.

45. The weighing scales as recited in claim 44, wherein the at least one electrode includes at least two electrodes, and wherein the panel includes two gripping areas each disposed on a side of the panel and each encompassing at least one of the at least two electrodes.

46. The weighing scales as recited in claim 45, wherein the two gripping areas are a wavy or profiled edge of the panel configured to allow a precise positioning of four fingers when a hand is disposed around or behind the two gripping areas.

47. The weighing scales as recited in claim 44, wherein the panel includes a center panel and two side panels.

48. The weighing scales as recited in claim 47, wherein the operating unit includes at least one operating element, and wherein the at least one operating element extends through the center panel and the two side panels so as to connect the side panels to each other and to the at least one of the pillar and the pillar head.

49. The weighing scales as recited in claim 39, wherein the at least one electrode is configured in the form of a vapor-deposited surface composed of an electrically conductive material, wherein the vapor-deposited surface is a metal surface.

50. The weighing scales as recited in claim 49, wherein the at least one electrode includes a curved strip.

51. The weighing scales as recited in claim 39, wherein the pillar is fastened directly on the weighing base.

52. The weighing scales as recited in claim 39, wherein the processor and the power source are disposed in one of the pillar and the pillar head, and wherein the power source includes one of a battery and an accumulator.

53. The weighing scales as recited in claim 39, wherein the weighing base includes a wheelchair ramp.

54. The weighing scales as recited in claim 39, wherein an integral part of the weighing base is configured to fold open so as to create a ramp.

55. The weighing scales as recited in claim 39, wherein the weighing base includes at least one support bar configured to enable a wheelchair user to pull himself and a wheelchair onto the weighing base by holding the at least one support bar.

56. The weighing scales as recited in claim 55, wherein the at least one support bar includes the at least one electrode so as to measure the body-specific information when a person holds on to the at least one support bar.

57. The weighing scales as recited in claim 39, further comprising a printer disposed in at least one of the pillar and the pillar head and configured to print data measured results.

58. The weighing scales as recited in claim 57, further comprising at least one interface disposed in at least one of the pillar and the pillar head and configured to transmit data.
